(19) United States
(12) Patent Application Publication
(10) Pub. No.: US 2015/0171788 A1
(43) Pub. Date: Jun. 18, 2015

(54) SOLAR MODULE JUNCTION BOX BYPASS DIODE

(71) Applicant: Gabriela Elena Bunea, San Jose, CA (US)

(72) Inventor: Gabriela Elena Bunea, San Jose, CA (US)

(21) Appl. No.: 14/108,140

(22) Filed: Dec. 16, 2013

(51) Int. Cl. H02S 40/34; H02S 30/10; H02B 1/48

(52) U.S. Cl. CPC H02S 40/34; H02B 1/48; H02S 30/10

(57) ABSTRACT

A junction box for a photovoltaic module can include a bypass diode. The bypass diode can include incoming and outgoing leads that can include respective stress relief features.

### BACKGROUND

Photovoltaic (PV) cells, commonly known as solar cells, are well known devices for conversion of solar radiation into electrical energy. Generally, solar radiation impinging on the surface of, and entering into, the substrate of a solar cell creates electron and hole pairs in the bulk of the substrate. The electron and hole pairs migrate to p-doped and n-doped regions in the substrate, thereby creating a voltage differential between the doped regions. The doped regions are connected to the conductive regions on the solar cell to direct an electrical current from the cell to an external circuit. When PV cells are combined in an array such as a PV module, the electrical energy collect from all of the PV cells can be combined in series and parallel arrangements to provide power with a certain voltage and current.

Bypass diodes can be used in solar applications to protect against reverse bias events as well as for temperature suppression of hot spots.

### BRIEF DESCRIPTION OF THE DRAWINGS

FIG. 1 illustrates an example solar module configured to implement the disclosed junction box, according to some embodiments.

FIG. 2 is a diagram illustrating an example junction box with stress relief features, according to some embodiments.

FIGS. 3-10 illustrate example solar module junction box strain relief features, according to various embodiments.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” stress relief feature does not necessarily imply that this stress relief feature is the first stress relief feature in a sequence; instead the term “first” is used to differentiate this stress relief feature from another stress relief feature (e.g., a “second” stress relief feature).

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

This specification first describes an example solar module that can implement the disclosed junction box with stress relief features. The specification then includes a description of an example junction box with stress relief features followed by various example stress relief features.

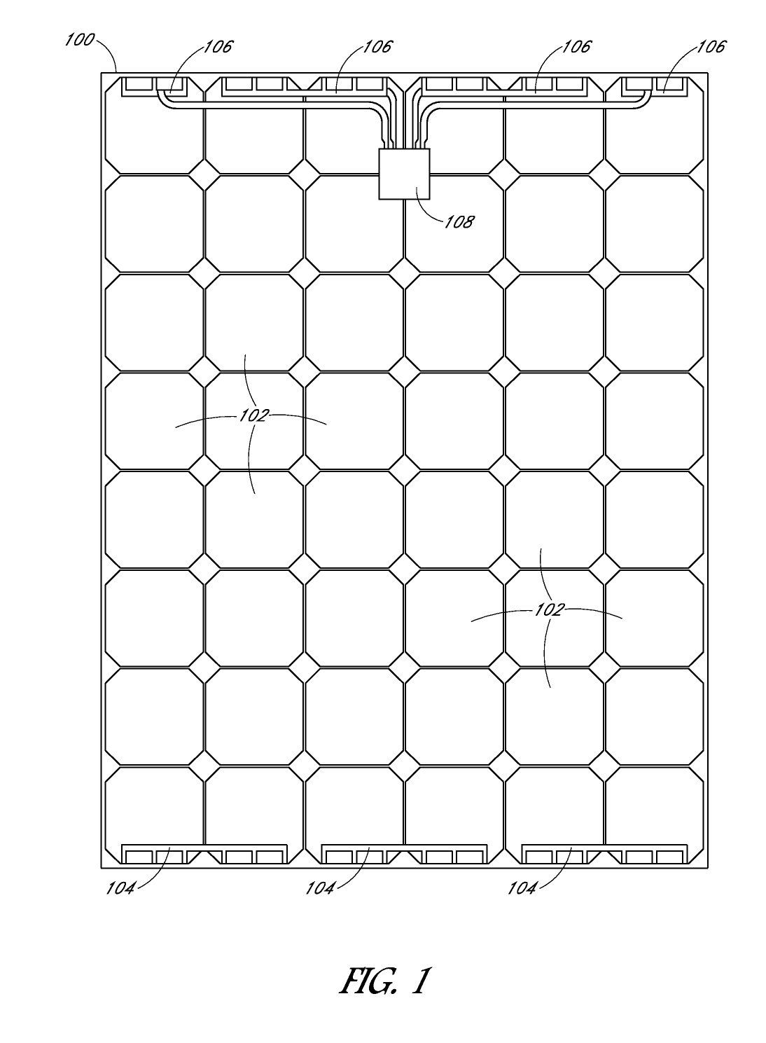

Turning now to FIG. 1, an example PV module that includes the disclosed junction box is shown. The PV module has a front side that faces the sun during normal operation and a back side opposite the front side. The PV module can include a frame and a laminate that includes a plurality of PV cells. The laminate can include one or more encapsulant layers that surround and enclose the PV cells. A cover (e.g., glass or some other transparent or substantially transparent material) can be laminated to the encapsulant layers. The laminate can have a backsheet that is the backmost layer of the laminate and provides a weatherproof and electrically insulating layer that protects the rest of the laminate. The backsheet can be a polymer sheet, and can be laminated to the encapsulant layer(s) of the laminate, or it can be integral with one of the encapsulant layers.

FIG. 1 illustrates the backside of PV module 100. Note that certain components, such as the PV cells, busbars, and connectors are illustrated as dashed lines in FIG. 1 to represent that those components would be at least partially covered by the backsheet and therefore not visible as shown when viewed from the backside. Such a depiction of FIG. 1 is provided for ease of understanding of the various components of PV module 100.

As shown, PV module 100 includes a number of PV cells 102. Although PV module 100 illustrates an array of 48 PV cells 102, other PV modules include other numbers of PV cells, such as 96 cells, 128 cells, etc. Moreover, not shown in great detail, the six columns of PV cells 102 are interconnected such that adjacent PV cells 102 within a given column are connected serially to one or more other adjacent PV cells 102 in the column. As shown, groups of two columns of PV cells are connected serially by cell connection pieces 104.

At one end of each column/string of cells, busbars 106 couple the string of cells electrically to junction box 108. Junction box 108 is, in turn, mechanically coupled to PV module 100. For example, in one embodiment, junction box 108 can be mechanically coupled to the backsheet (or frame) of PV module 100. In such an embodiment, busbars 106 penetrate the backsheet such that the busbars 106 can be accessed and coupled to junction box 108. Junction box 108 can also be coupled (e.g., via a cable) to an inverter (whether a microinverter mounted to the module or a remotely located inverter) to convert direct current (DC) power to alternating current (AC) power.

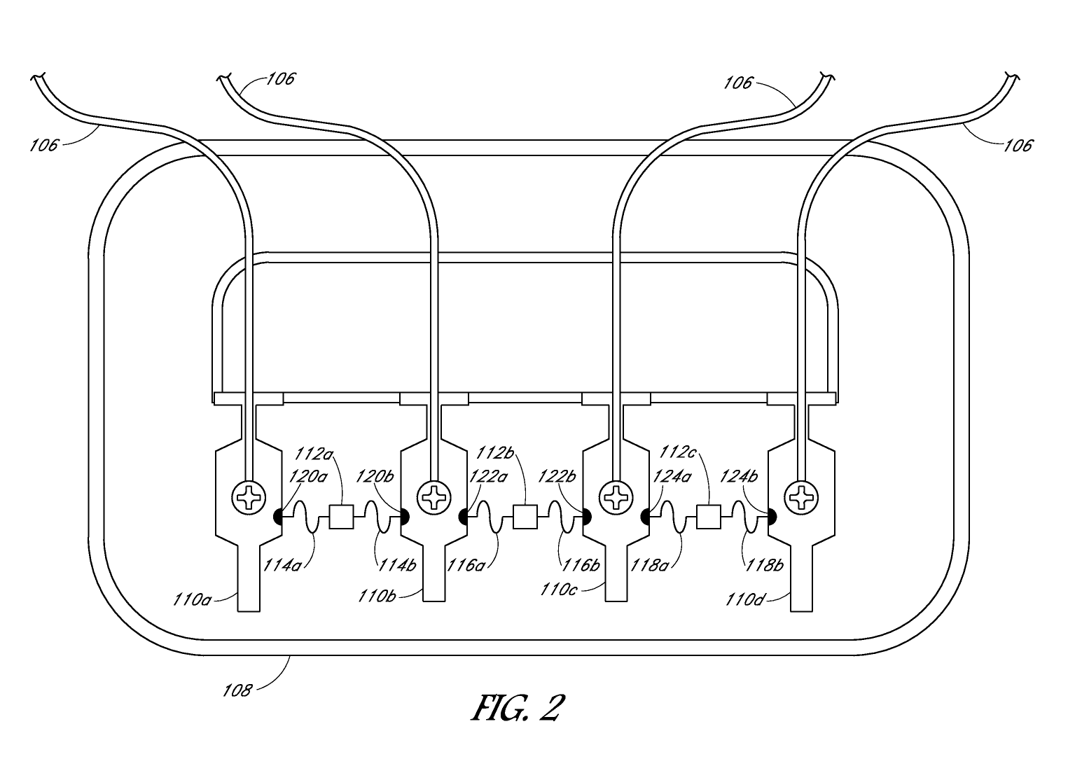

Turning now to FIG. 2, an example junction box with stress relief features is illustrated, according to various embodiments. As shown, junction box 108 is coupled to a number of busbars 106 (four in the example of FIG. 2) of a PV module to provide an electrical connection between strings of PV cells and the junction box.

As illustrated, junction box 108 includes three bypass diodes, 112a, 112b, and 112c, each of which has respective incoming and outgoing leads. The incoming and outgoing leads are made of a conductive material, such as metal wire, non-metal conductive wire, or ribbons, among other examples. In other examples, the junction box can include other numbers of bypass diodes (e.g., a single bypass diode, two bypass diodes, six bypass diodes, etc.). In one embodiment, the number of bypass diodes can be dependent on the number of strings of PV cells. In such an embodiment, the bypass diode can protect a given string of PV cells from reverse bias conditions and also provide for temperature suppression of hot spots for that string.

In various embodiments, junction box 108 also includes a number of rails, such as rails 110a, 110b, 110c, and 110d, which are configured to provide a conduction path between busbars 106 to the bypass diodes and to a connector (not shown in FIG. 2) that allows the junction box to be coupled to an inverter (directly or through a cable). In the illustrated example, the coupling from busbar to rail is completed by tightening a screw to secure the busbar in contact with the rail. In other embodiments, other coupling techniques can be used, such as soldering, welding, other types of clamping, etc.

In the illustrated embodiment, a first rail (e.g., rail 110a) is coupled to the incoming lead of a bypass diode (e.g., bypass diode 112a) with the first rail being configured to receive current from a first plurality (e.g., a string) of PV cells of the PV module. As shown, a second rail (e.g., rail 110b) is coupled to the outgoing lead of the bypass diode with the second rail being configured to receive current from a second plurality (e.g., another string) of PV cells of the PV module.

Also in the illustrated embodiment, rail 110b is coupled to the incoming lead of bypass diode 112b, a third rail (rail 110c) is coupled to the outgoing lead of bypass diode 112b and the incoming lead of bypass diode 112c. Additionally, FIG. 2 illustrates the outgoing lead of bypass diode 112c coupled to a fourth rail (rail 110d). The third and fourth rails can be configured to receive current from third and fourth pluralities of PV cells of the PV module, respectively.

In various embodiments, the leads of the bypass diode(s) can be coupled to the rails via couplings 120a, 120b, 122a, 122b, 124a, and 124b. The couplings can be soldered, welded, and/or clamp connections, among other examples. For example, the couplings between rails and bypass diode leads can be achieved with electrically conductive adhesives, mechanical fasteners, or other coupling techniques such that current can flow between a rail and bypass diode.

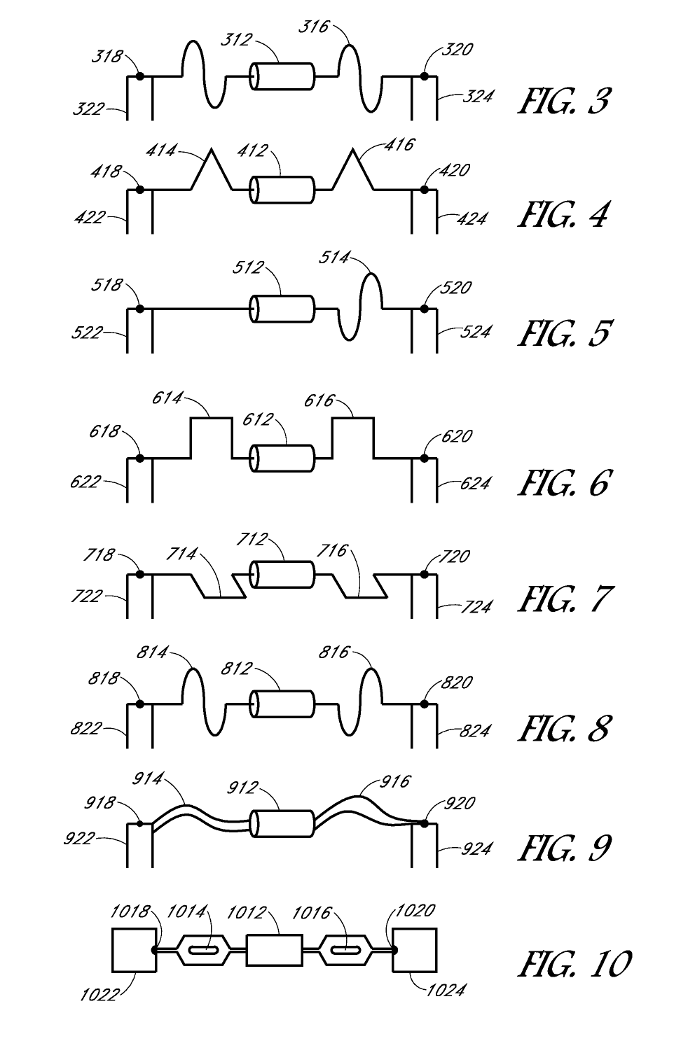

In instances in which the coupling between a bypass diode lead and rail is a solder or weld joint, temperature and/or humidity fluctuations over time in the field can compromise the coupling. For example, physical failure (e.g., cracks) can develop in the solder or weld joint. Such cracks can lead to long term reliability issues, including arcing in some circumstances. To address such potential reliability issues, in various embodiments, one or both of the incoming lead and outgoing leads can include a stress relief feature, such as stress relief features 114a, 114b, 116a, 116b, 118a, and 118b. Various other example stress relief features are shown in FIGS. 3-10. The disclosed stress relief features can provide stress/strain relief thereby improving reliability and durability of the coupling between the bypass diode lead and rail.

The example stress relief features in FIG. 2 are approximately S shaped and are included on both leads of the bypass diode. FIG. 3 illustrates an enlarged view of such S-shaped stress relief features 314 and 316 for diode 312. As shown, the stress relief feature has a first bend in a first direction relative to the bypass diode and a second bend in a second direction relative to the bypass diode. As illustrated, the incoming lead of bypass diode 312 is coupled to rail 322 via coupling 318 and the outgoing lead of bypass diode 312 is coupled to rail 324 via coupling 320.

FIG. 4 illustrates example stress relief features according to one embodiment. In the example of FIG. 4, triangular-shaped stress relief features 414 and 416 for diode 412 are shown. Note that in such an example, the stress relief features are entirely in one direction relative to the diode unlike the example of FIG. 3. As is the case with FIG. 3, the incoming lead of bypass diode 412 is coupled to rail 422 via coupling 418 and the outgoing lead of bypass diode 412 is coupled to rail 424 via coupling 420.

FIG. 5 illustrates example stress relief features according to one embodiment. In the example of FIG. 5, only the outgoing lead for bypass diode 512 includes a stress relief feature, in the form of stress relief feature 514. As is the case with FIG. 3, the incoming lead of bypass diode 512 is coupled to rail 522 via coupling 518 and the outgoing lead of bypass diode 512 is coupled to rail 524 via coupling 520.

FIG. 6 illustrates example stress relief features according to one embodiment. In the example of FIG. 6, rectangular-shaped stress relief features 614 and 616 for diode 612 are shown. Note that, in such an example and similar to FIG. 4, stress relief features 614 and 616 are entirely in one direction relative to the diode unlike the example of FIG. 3. As is the case with FIG. 3, the incoming lead of bypass diode 612 is coupled to rail 622 via coupling 618 and the outgoing lead of bypass diode 612 is coupled to rail 624 via coupling 620.

FIG. 7 illustrates example stress relief features according to one embodiment. The example of FIG. 7 is the same as the example of FIG. 6 except that the stress relief features of FIG. 7 are out of plane from rails 722 and 724. Note that the stress relief features of FIG. 7 can be configured to be perpendicular to the rails or at some other angle relative to the rails. In one embodiment, the stress relief features of FIGS. 3-6 and 8 are substantially parallel to the surface of the junction box that is coupled to the photovoltaic module. FIG. 7, being out of plane of rails 722 and 724 may not be substantially parallel to the surface of the junction box. As is the case with FIG. 3, the incoming lead of bypass diode 712 is coupled to rail 722 via coupling 718 and the outgoing lead of bypass diode 712 is coupled to rail 724 via coupling 720.

FIG. 8 illustrates example stress relief features according to one embodiment. The example of FIG. 8 is the similar to the example of FIG. 3 except that stress relief features are in a mirror configuration relative to one another such that the bends in the stress relief features, when viewed from closest to furthest relative to the bypass diode, are configured in the same direction(s). As is the case with FIG. 3, the incoming lead of bypass diode 812 is coupled to rail 822 via coupling 818 and the outgoing lead of bypass diode 812 is coupled to rail 824 via coupling 820.

FIG. 9 illustrates example stress relief features according to one embodiment. The example of FIG. 9 illustrates an embodiment in which the leads and stress relief features are a ribbon. Note that although the example of FIG. 9 shows the stress relief features and leads in free form, in some embodiments, the ribbons may be shaped (e.g., in one of the positions of FIGS. 3-8 or some other position) after soldering/welding to reduce stress in the joints. As is the case with FIG. 3, the incoming lead of bypass diode 912 is coupled to rail 922 via coupling 918 and the outgoing lead of bypass diode 912 is coupled to rail 924 via coupling 920.

FIG. 10 illustrates a top down view of example stress relief features according to one embodiment. The example of FIG. 10 illustrates an embodiment in which stress relief features 1014 and 1016 are formed by holes and/or cuts in the lead (wire, ribbon, etc.). The illustrated hole regions (stress relief features 1014 and 1016) are included in a widened portion of the lead but note that other embodiments may not include a widened lead. Instead, the holes may simply remove a portion or portions or the lead(s). Holes can be any shape (e.g., circular, triangular, free form, rectangular, etc.) and can overlap the edge of the lead such that the hold is not completely surrounded by the lead, in contrast to the holes shown in FIG. 10 that are entirely surrounded by the lead. As is the case with FIG. 3, the incoming lead of bypass diode 1012 is coupled to rail 1022 via coupling 1018 and the outgoing lead of bypass diode 1012 is coupled to rail 1024 via coupling 1020.

In various embodiments, the leads can be fabricated with the stress relief features. In other embodiments, the stress relief features can be added at the time the bypass diode and its leads are coupled to the rails in the junction box. For example, the bypass diode and its leads can be longer than the distance between two adjacent rails. One lead (e.g., incoming lead) can be coupled (e.g., soldered, welded, etc.) to a rail and then one or both leads can be shaped to include stress relief bends such that the bypass diodes and both leads fit between the rails. The second lead (e.g., outgoing lead) can then be coupled to the rail.

The disclosed stress relief features can provide stress/strain relief thereby improving reliability and durability of the coupling between the bypass diode lead and rail. As a result, the risk of arcing, fire, and other performance issues over a long time period can be reduced.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A junction box for a photovoltaic module, comprising:
a bypass diode that includes incoming and outgoing leads, wherein the incoming and outgoing leads include a respective stress relief feature;
a first rail coupled to the incoming lead of the bypass diode, wherein the first rail is configured to receive current from a first plurality of photovoltaic cells of the photovoltaic module; and
a second rail coupled to the outgoing lead of the bypass diode, wherein the second rail is configured to receive current from a second plurality of photovoltaic cells of the photovoltaic module.

2. The junction box of claim 1, wherein the first and second rails are coupled to the incoming and outgoing leads of the bypass diode, respectively, via solder, welded, or clamped connections.

3. The junction box of claim 1, wherein each stress relief feature includes at least one bend in the respective lead.

4. The junction box of claim 1, wherein the stress relief features include a first portion in a first direction relative to a plane defining the respective lead and a second portion in a second opposite direction relative to the plane.

5. The junction box of claim 1, wherein the stress relief features are ribbons.

6. The junction box of claim 1, wherein the stress relief features are substantially parallel to a surface of the junction box that is configured to be coupled to the photovoltaic module.

7. The junction box of claim 1, wherein the stress relief features are holes in the respective leads.

8. A photovoltaic module, comprising:
first and second pluralities of photovoltaic cells;
a first busbar coupled to the first plurality of photovoltaic cells;
a second busbar coupled to the second plurality of photovoltaic cells; and
a junction box coupled to the first and second busbars, wherein the junction box includes:
a first bypass diode that includes first and second leads that each includes a respective stress relief feature,
a first rail coupled to the first busbar and to the first lead of the first bypass diode, and
a second rail coupled to the second busbar and to the second lead of the first bypass diode.

9. The photovoltaic module of claim 8, further comprising:
third and fourth pluralities of photovoltaic cells;
a third busbar coupled to the third plurality of photovoltaic cells; and
a fourth busbar coupled to the fourth plurality of photovoltaic cells;
wherein the junction box includes:
second and third bypass diodes that each include respective first and second leads, wherein the first and second leads of the second and third bypass diodes each includes a respective stress relief feature,
a third rail coupled to the third busbar and to the second lead of the second bypass diode and to the first lead of the third bypass diode, and
a fourth rail coupled to the fourth busbar and to the second lead of the third bypass diode.

10. The photovoltaic module of claim 8, wherein the first rail is coupled to the first lead of the first bypass diode via a solder connection.

11. The photovoltaic module of claim 8, wherein each stress relief feature includes at least one bend in the respective lead.

12. The photovoltaic module claim 8, wherein the first lead and its respective stress relief feature are included in a ribbon.

13. The photovoltaic module of claim 8, wherein the stress relief features are holes in the first and second leads, respectively.

14. The photovoltaic module of claim 8, wherein the stress relief features are substantially parallel to a surface of the junction box that is coupled to the photovoltaic module.

15. The photovoltaic module of claim 8, wherein a portion, closest to the first bypass diode, of the stress relief feature of the first lead is in a first direction and wherein a portion, closest to the first bypass diode, of the stress relief feature of the second lead is in a second different direction.

16. A junction box for a photovoltaic module, comprising:
a first bypass diode that includes first and second leads, wherein at least one of the first or second leads includes a stress relief feature;
a first rail coupled to the first lead of the first bypass diode, wherein the first rail is configured to receive current from a first plurality of photovoltaic cells of the photovoltaic module; and
a second rail coupled to the second lead of the first bypass diode, wherein the second rail is configured to receive current from a second plurality of photovoltaic cells of the photovoltaic module.

17. The junction box of claim 16, wherein the first and second leads each include the stress relief feature.

18. The junction box of claim 16, further comprising:
a second bypass diode that includes first and second leads, wherein at least one of the first or second leads of the second bypass diode includes a stress relief feature, wherein the second rail is coupled to the first lead of the second bypass diode; and
a third rail coupled to the second lead of the second bypass diode, wherein the third rail is configured to receive current from a third plurality of photovoltaic cells of the photovoltaic module.

19. The junction box of claim 16, wherein the stress relief feature includes at least one bend in the respective lead.

20. The junction box of claim 16, wherein the stress relief feature is substantially parallel to a surface of the junction box that is coupled to the photovoltaic module.
